(19) United States
(12) Patent Application Publication
(10) Pub. No.: US 2010/0192784 A1
(43) Pub. Date: Aug. 5, 2010

(54) COOKING APPLIANCE, CONTROLLING SYSTEM FOR COOKING APPLIANCE AND CONTROLLING METHOD FOR COOKING APPLIANCE

(75) Inventors: Mi Hwa Shim, Changwon City (KR); Jun Hyun Park, Changwon City (KR); Soo Cheol Yi, Changwon City (KR); Won Kyoung Park, Changwon City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/522,788

(22) PCT Filed: Nov. 15, 2007
(86) PCT No.: PCT/KR2007/005747

§ 371 Date: Apr. 9, 2010

(30) Foreign Application Priority Data
Jan. 11, 2007 (KR) 10-2007-0003283
Jan. 11, 2007 (KR) 10-2007-0003285
Jan. 11, 2007 (KR) 10-2007-0003299
Jan. 25, 2007 (KR) 10-2007-0007801

(51) Int. Cl. A47J 36/00

(52) U.S. Cl. 99/325

(57) ABSTRACT

Provided is a controlling system for a cooking appliance. The controlling system includes a cooking appliance, a server and a network. The cooking appliance includes at least a heating unit. The server receives reception information from the cooking appliance and is connected with the cooking appliance to send transmission information processed with reference to the reception information to the cooking appliance. The network includes at least one node to connect the cooking appliance with the server, accordingly, the cooking appliance is controlled properly so that user's satisfaction can be improved.

### TECHNICAL FIELD

The present disclosure relates to a cooking appliance, a controlling system for a cooking appliance, and a controlling method for a cooking appliance.

### BACKGROUND ART

A user usually cooks food based on experience. Alternatively, a user may learn a recipe from, e.g., a cookbook. Since the user obtains food information from limited resources, the obtained food information may not include specific information such as preference for food, conditions of cooked food, or a specific example of cooking food because of space limitation of books. Thus, if a user uses a book for cooking, the user may cook by guess because of insufficient information of the book. A user may obtain information associated with a food via the Internet. However, in this case, the user may feel inconvenience because they must go to, e.g., a study to learn a recipe via the Internet.

Also, a recipe for cooking a certain kind of food is predetermined and fixed in general, but in actuality, the recipe may vary with a food condition, a food kind, the amount of food, and eater's preference. Thus, following the predetermined recipe may cause the food to be cooked indiscriminately, and thus the food cannot be cooked in the way that an eater wants.

### DISCLOSURE OF INVENTION

### Technical Problem

Embodiments provide a cooking appliance, a controlling system for a cooking appliance, and a controlling method for a cooking appliance capable of providing food-associated information to a user in real time and allowing the user to easily obtain various information associated with the food by diversifying a range of food information provided to the user.

Embodiments also provide a cooking appliance, a controlling system for a cooking appliance, and a controlling method for a cooking appliance capable of providing a user with an optimum recipe according to specifications and conditions of the cooking appliance.

### Technical Solution

In one embodiment, a controlling system for a cooking appliance includes: a cooking appliance including at least a heating unit; a server connected to the cooking appliance to receive reception information from the cooking appliance and send transmission information processed with reference to the reception information to the cooking appliance; and a network including at least one node to connect the cooking appliance with the server.

In another embodiment, a controlling system for a cooking appliance includes: a wireless transmitter mounted in a cooking appliance; a terminal receiving transmission information sent from the wireless transmitter; and a server connected to the terminal via a network and providing food-associated information with respect to the transmission information sent from the terminal, wherein the wireless transmitter sends at least specific food information, and the food-associated information is information associated with the specific food information.

In still another embodiment, a controlling system for a cooking appliance includes: a cooking appliance including therein a first communication unit; a terminal including therein a second communication unit installed to receive information of the cooking appliance from the first communication unit; and a server processing information of the cooking appliance input from the terminal and sending reference information of the cooking appliance to the terminal.

In even another embodiment, a controlling system for a cooking appliance includes: a cooking appliance including therein at least a heater; and a server connected to the cooking appliance. The cooking appliance includes: a memory storing current control information; an operating unit operating according to the current control information; a detecting unit detecting an operational result of the operating unit; and a communication unit sending at least actual state information detected at the detecting unit to the server, wherein the server generates corrected control information with reference to at least the actual state information and sends the corrected control information to the cooking appliance, and the cooking appliance changes the corrected control information to current control information.

In yet another embodiment, a cooking appliance includes: an operating unit including at least a heater; a detecting unit detecting actual state information resulting from an operation by the operating unit; and a memory storing current control information for currently operating at least the operating unit, and the actual state information.

In further embodiment, a controlling system for a cooking appliance includes: a cooking appliance including a character input unit through which a user inputs a character, and a display unit displaying information; and a server connected to the cooking appliance via a network and including a memory storing therein food information of various food. A question input through the character input unit is sent to the server, and an answer to the question is sent to the cooking appliance and displayed on the display unit to be used to cook food.

In a still further embodiment, a controlling system for a cooking appliance that cooks food by heating includes a cooking appliance including a character input unit through which a user inputs a question using characters; a display unit displaying the characters input through the character input unit and an answer to the question; a memory storing therein the answer to the question; and a cooking-appliance control unit searching the memory for the answer to the question and controlling such that the searched answer is displayed on the display unit.

In even further embodiment, a controlling method for a cooking appliance includes: inputting a question using characters through a character input unit of a cooking appliance; searching a memory of the cooking appliance and/or a memory of a server connected with the cooking appliance via a network for an answer to the question; outputting the answer to a display unit of the cooking appliance; storing cooking information including the answer in the memory of the cooking appliance, the cooking information being used to control the cooking appliance; and operating the cooking appliance according to the cooking information.

In yet further embodiment, a controlling method for a cooking appliance includes: operating a cooking appliance according to pre-stored current control information; measuring actual state information of the cooking appliance resulting from an operation based on the current control information; comparing the actual state information with ideal target state information which the current control information is aimed at; and calibrating the current control information of the cooking appliance into corrected control information.

### ADVANTAGEOUS EFFECTS

According to embodiments, a user can acquire recent information associated with food in real time, and a range of food information provided to the user is diversified. Accordingly, the user can conveniently manipulate a cooking appliance in a specified and correct manner depending on a state of the food, obtain information optimized according to specification information of the cooking appliance and use the cooking appliance for a long time without any inconvenience as if it is new. Also, since the amount of use information of the cooking appliance and food information recorded in an internal memory can be increased, control information for the cooking appliance can be calibrated, which offers convenience in use. Also, a limited usable term of the cooking appliance, which results from a controlling method can be overcome, and a cooking process of the user can be guided correctly.

### BRIEF DESCRIPTION OF THE DRAWINGS

FIG. 1 is a block diagram of a controlling system for a cooking appliance according to a first embodiment.

FIG. 2 illustrates an example of information recorded on a radio-frequency (RF) tag according to the first embodiment.

FIG. 3 is a flowchart for explaining a controlling method for a cooking appliance according to the first embodiment.

FIG. 4 is a block diagram of a controlling system for a cooking appliance according to a second embodiment.

FIG. 5 is a table of information transmitted/received between a terminal and the cooking appliance.

FIG. 6 is a flowchart for explaining a method for providing food information according to the second embodiment.

FIG. 7 is a block diagram of a controlling system for a cooking appliance according to a third embodiment.

FIG. 8 is a flowchart of a method for calibrating control information of the cooking appliance according to the third embodiment.

FIG. 9 is an exemplary view for showing current control information, target state information, actual state information, and corrected control signal.

FIG. 10 is a block diagram of a controlling system for a cooking appliance according to a fifth embodiment.

FIG. 11 is a flowchart of a controlling method for a cooking appliance according to the fifth embodiment.

FIG. 12 is a perspective view of an oven being used for description according to a sixth embodiment.

FIG. 13 is a block diagram of a controlling system for a cooking appliance according to the sixth embodiment.

FIG. 14 is a flowchart of a cooking guide method according to the sixth embodiment.

FIG. 15 is a flowchart of a controlling method for a cooking appliance according to a seventh embodiment.

### MODE FOR THE INVENTION

Reference will now be made in detail to the preferred embodiments of the present invention, examples of which are illustrated in the accompanying drawings.

### First Embodiment

A controlling system for a cooking appliance according to this embodiment uses a radio frequency (RF) tag reading system including an RF tag and an RF reader. The RF tag reading system operates in such a manner that when the RF reader requests the RF tag to send tag data, the RF tag sends the tag data using a radio frequency to the RF reader. In this embodiment, the RF tag is provided in a cooking appliance, and the RF reader is provided in a terminal.

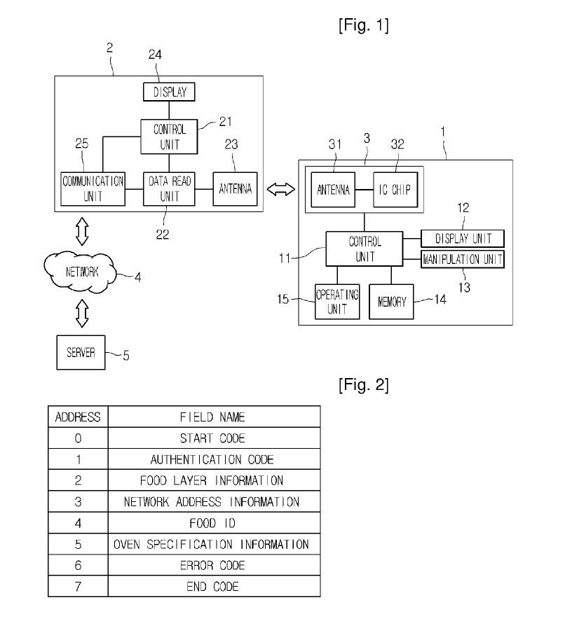

FIG. 1 is a block diagram of a controlling system for a cooking appliance according to the first embodiment.

Referring to FIG. 1, the controlling system for a cooking appliance includes an RF tag module 3 for storing unique information of a specific food, a terminal 2 including an RF reader module therein to read food-associated information from the RF tag module 3, a server 5 receiving the food-associated information from the terminal 2 and processing response information, and a network 4 connecting the server 5 with the terminal 2.

In detail, the RF tag module 3 is provided as a built-in component of a cooking appliance 1. In the following description, an oven is used as one example of the cooking appliance 1, but the cooking appliance 1 is not limited thereto and may be applied to a variety of cooking appliances such as a cooktop or a kitchen range.

The RF tag module 3 includes an integrated circuit (IC) chip 32 storing at least food-associated unique information, and an antenna 31 sending the food-associated unique information using a radio frequency. The cooking appliance 1 includes a plurality of components interworking with the RF tag module 3 and performing operations of the cooking appliance. In detail, the cooking appliance 1 includes a display unit 12 displaying e.g., an operational state of the cooking appliance 1, a manipulating unit 13 allowing a user to manipulate an operational state of the cooking appliance 1, a memory 14 storing various information required for operations of the cooking appliance 1, an operating unit 15 including at least one heating source to perform a heating operation of the cooking appliance 1, and a cooking-appliance control unit 11 controlling an overall control state of the cooking appliance 1.

The cooking-appliance control unit 11 characteristically controls the IC chip 32 to control information recorded in the IC chip 32.

The terminal 2 includes an antenna 23 for exchange of a high-frequency signal with the RF tag module 3, and a data read unit 22 processing information received through the antenna 23. Since the antenna 23 and the data read unit 22 serve as an RF reader, these two components may be collectively called an RF reader module. Also, the terminal 2 further includes a control unit 21 controlling an entire system of the terminal 2, a display 24 displaying state information and other information of the terminal 2, and a communication unit 25 performing communication between the terminal 2 and an external device.

The communication unit 25 accesses the server 5 via the network 4 to exchange data therebetween. The server 5 may be a server operated by a maker of the cooking appliance 1. Alternatively, the server may be a server of a home network, or a server on the Internet connected to the wired or wireless Internet network.

An operation of the controlling system for the cooking appliance will now be described.

First, a user selects a desired food through the manipulation unit 13. The selected food may be, for example, a pan vegetable pizza. Then, information of the selected food is sent to the RF tag module 3 under the control of the cooking-appliance control unit 11. Of course, the sent information is stored in the IC chip 32. For such an operation, the cooking-appliance control unit 11 and the RF tag module 3 may be connected by wire.

FIG. 2 shows an example of information recorded on the RF tag module 3.

Referring to FIG. 2, in a start code field a code indicating the start of data is recorded, and in an end code field a code indicating the end of data is recorded. An authentication code of the terminal that reads information, and a code used for authentication of the RF tag module 3 in the server 5 are recorded in an authentication code field. A code for detecting an error in data transmission is recorded in an error code field. The codes recorded in the respective fields are fundamentally required for operations of the RF tag reading system, and may vary with a specific state.

Besides the above information, other information is recorded on an RF tag of a food-information providing system according to this embodiment. The other information includes food layer information, a food identification (ID), and specification information of an oven in respective addresses. The food layer information and the food ID may be sent to the RF tag module 3 from the cooking-appliance control unit 11. The server network address and the specification information of the cooking appliance may be pre-stored in the IC chip 32 without being sent.

In detail, the food layer information is configured as a plurality of layers of lower menus. For example, the layer is represented as [0002] when the food is Western food, the layer is represented as [0001] when the Western food is pizza, the layer is represented as [0002] when the pizza is pan pizza, and the layer is represented as [0001] when the pan pizza is a vegetable pizza. As a result, the layer information includes layers of [0002/0001/0002/0001]. The food layer information may be selected from the memory 14 by a user.

An address information of the server 5 on a network may be an IP address on the Internet. The server 5 is a server of an oven maker and may be proposed in the form of an additional service for an oven consumer. The network 4 may be any one of wired/wireless networks. An example of the wired network may be an Internet network described above. The address information may be address information of a home network connected to a server installed at home. The wireless network may be used in the case of a portable terminal. The specification information of the cooking appliance is a name predetermined by the oven maker at the time of production. Using the specification information allows the server 5 to detect detailed specification information of the oven.

The food ID may be represented as a name such as [a vegetable pan pizza] that directly represents a name of the food, a combination of numbers such as [12345678] as an abbreviated number that allows the name to be easily recognized by the server, and a combination of other codes.

The specification information of the oven refers to an ID of the oven. When the specification information of the oven is sent to the server 5, an optimum process for cooking a specific food can be provided in more detail. For example, if a specific target oven has output power of 300 watts whereas a general oven has output power of 400 watts, a cooking method needs to be differently performed to implement an optimum cooking method, for example, a cooking time may be increased.

Referring to FIG. 1, information stored in the IC chip 32 is sent to the terminal 2 via the antenna 31, and the information sent to the terminal 2 is read by the data read unit 22 and sent to the outside by the communication unit 25. Specifically, the information is sent to the server 5 via the network 4 under the control of the control unit 21.

The information sent to the server 5 is recognized as a specific food by various methods, and then information associated with the food is collected. The collected information is sent to the terminal 2 via the network 4, and the sent information is displayed through the display 24. Although not shown, the information may be output as audio information through a speaker.

When the food-associated information is output through the display 24, a user may acquire additional information of the food with reference to the output information. Examples of the additional information of the food may include information of another food associated with the corresponding food, an optimum cooking method suitable for an oven to be used, information of video images showing a cooking process of the corresponding food, or information of people's preference for a specific food.

As mentioned above, the user can view the food-associated information in real time and easily acquire various information by diversifying a range of food information provided to the user. Also, the user can obtain an optimum cooking method of the food according to a state of the cooking appliance.

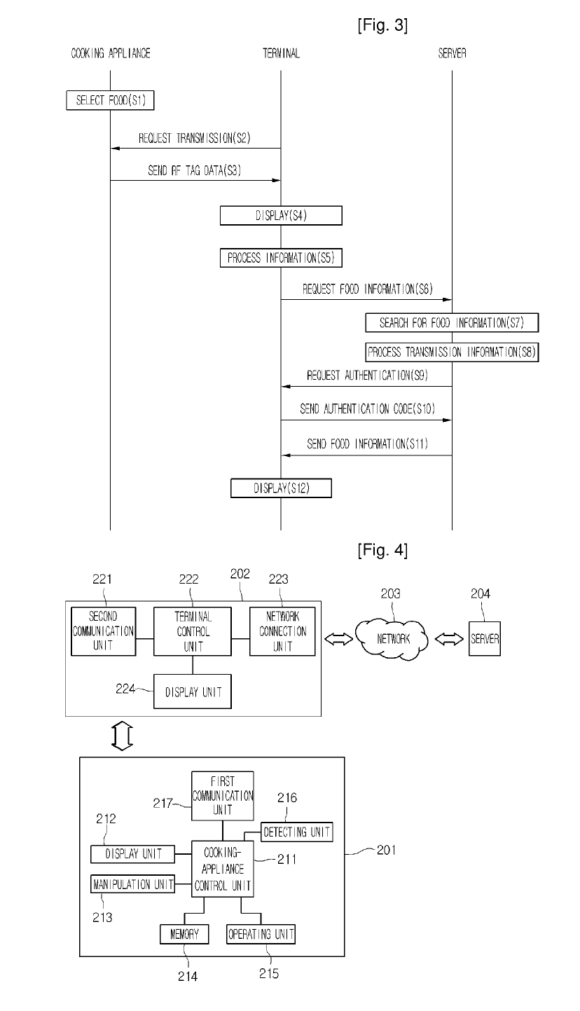

FIG. 3 is a flowchart of a controlling method for a cooking appliance according to this embodiment.

Referring to FIG. 3, in operation S1, a user selects a desired food by manipulating the manipulation unit 13. A process for selecting the food is a layered process and may be performed as a process of selecting information from the memory 14 under the control of the cooking-appliance control unit 11. For example, the food may be selected by a layered process of western food->pizza->pan pizza->vegetable pizza.

When the pan vegetable pizza is selected finally, the information is sent to the RF tag module 3 under the control of the cooking-appliance controller 11 and stored in the IC chip 32.

After the user's selection is completed, the cooking appliance 1 may be manipulated such that the food is cooked by a pre-stored cooking process of a cooking method for the corresponding food. If necessary, an additional process according to this embodiment may be performed to obtain additional information.

A user who wants to obtain additional information of a specific food brings a terminal including an RF module close to an oven. Then, in operation S2, the terminal 2 requests the RF tag module 3 to send the information recorded therein.

Thereafter, in operation S3, the information recorded in the RF tag module 3 is sent to the terminal 2. The RF tag module 3 may send data only when the terminal 2 has been already authenticated through an authentication process. By such an authentication process, approach of another RF reader which is not a terminal may be neglected.

In operation S4, after receiving the data from the RF tag, the terminal 2 displays specific information of the food. The displayed information may include information of an ID of the food such as [pan vegetable pizza], layer information of the food, address information of the server on the network, and specification information of the oven. In operation S5, the user processes the information being displayed. Thus, in operation S6, information associated with the food is requested when the food information and specification information of the oven are sent. The process of processing the information at the terminal 2 may be preset between the terminal 2 and the server 4 operated by an oven maker. For example, it can be preset that layer information of a food is contained in a specific transmission field and sent to the server 5.

In operation S7, the server 5 receiving the request to send the food information searches for information associated with the corresponding food therein or collects data of an external system. In operation S8, the server 5 processes the information into information that must be directly sent. As described above, if information of a vegetable pizza is sent, the information being processed may include information of other food associated with the requested food, e.g., bulgogi pizza, information of a detailed and recent recipe of the vegetable pizza using a specific oven, video information of a detailed cooking process, and preferences of other eaters for the selected food.

Before providing the terminal 2 with the food information, the server 5 requests authentication information in order to identify whether the oven or the terminal having sent the corresponding request is authorized to receive the food information in operation S9. In operation S10, the terminal 2 receiving the authentication information request sends an authentication code. The authentication code may be information received from the RF tag module 3.

In operation S11, after the received authentication code is authenticated, the server 5 sends the processed food information to the terminal 2.

In operation S12, the terminal 2 displays the received various information or expresses it as sounds to provide the user with the additional food information.

The user acquiring the additional food information becomes able to cook food based on the information, and thus user's convenience is improved because of the various food-associated information.

For example, the user can obtain more specific information for operating the oven. When the information is processed by manipulating the terminal 2 in operation S5 while vegetable pizza is cooked, an entire weight of a cooking material or a cooking degree may be further selected. Then, a method for cooking the food to an optimum state may be sent from the server 5 according to the selected information.

This embodiment may have the following modification example.

The authentication request operation S9 and the authentication code sending operation S10 between the server and the terminal may be performed between the food information request operation S6 and the food information sending operation S11 between the terminal and the server. The order of performing those processes is irrelevant. Therefore, after the authentication request operation S9, the food information may be searched or the information may be processed.

### Second Embodiment

In the first embodiment, a cooking appliance can further acquire information of a food that a user wants to cook, by using a terminal on the basis of information input by the user. However, the method of the first embodiment has a limitation in that the acquired information is usable as cooking information of the cooking appliance only after the user decides to use the information. To overcome the limitation, a second embodiment proposes a method for automatically recording and updating cooking-appliance control information to a cooking appliance so that the user can more conveniently use the cooking appliance even in the case where the cooking appliance is deteriorated over time. Parts of this embodiment to which the description of the first embodiment is applicable will be described briefly and the description of the first embodiment will be applied thereto.

FIG. 4 is a block diagram of a controlling system for a cooking appliance according to the second embodiment.

Referring to FIG. 4, the controlling system for a cooking appliance includes a cooking appliance 201, a terminal 202 performing communication with the cooking appliance 201, and a server 204 connected to the terminal 202 via a network 203.

An oven may be used as one example of the cooking appliance. The cooking appliance 201 includes a display unit 201, a manipulation unit 213, a memory 214, an operating unit 215, and a detecting unit 216, centering on a cooking-appliance control unit 211. The display unit visually displays an operational state of the cooking appliance 201, the manipulation unit 213 allows a user to manipulate the cooking appliance 201, and the memory 214 stores various information required for an operation of the cooking appliance 201. The operating unit 215 is used for a heating operation of the cooking appliance 201 and includes, e.g., a heater, and the detecting unit 216 detects an operational state of the cooking appliance 201. Also, the cooking appliance 201 further includes a first communication unit 217 transmitting/receiving various information with the terminal 202 under the control of the cooking-appliance control unit 211.

The terminal 202 includes a second communication unit 221, a terminal control unit 222, a display unit 224, and a network connection unit 223. The second communication unit 221 transmits/receives a signal with the first communication unit 217, and the terminal control unit 222 controls the entire terminal 202. The display unit 224 is mounted in the terminal 202, and the network connection unit 223 connects the terminal 202 to the network 203 to allow signal transmission/reception with a server 204. The display unit 224 may not be provided if necessary and is not an essential element in implementing this embodiment.

The network 203 may be a wired network or a wireless network. Wireless communication units transmitting/receiving signals using a high frequency may be used as the respective first and second communication units 217 and 221, and an RF tag reading system or a plurality of RF tag reading systems may be applied thereto.

An operation of the controlling system for the cooking appliance will now be described.

First, the cooking appliance 201 is operated by being manipulated freely by a user in a normal state. Operation information of the cooking appliance 201 may be stored in the memory 214. An example of the information stored in the memory 214 may include manipulation information by user, and temperature information, moisture information and smoke generation information during the actual operation of the cooking appliance 201 with reference to the manipulation information. The operation information of the cooking appliance may be stored sequentially by the above process. At this time, capacity of the memory 214 is not important because of a recent explosive increase in storage capacity.

In the memory 214 specification information of a corresponding specific cooking appliance, and an ID of the cooking appliance are further stored.

The user can perform communication with the cooking appliance 201 by using the terminal 202. The communication between the terminal 202 and the cooking appliance 201 may be general wireless communication or wired communication. For the communication, the RF tag reading system may be used as described above. If the RF tag reading system is used, the first communication unit 217 may further include an antenna and an IC chip therein, and the IC chip may operate to store therein information of the memory 214 under the control of the cooking-appliance control unit 211. In this state, if the second communication unit 221 operating as an RF reader approaches thereto, the first communication unit 217 and the second communication unit 221 are synchronized with each other and transmit/receive information therebetween.

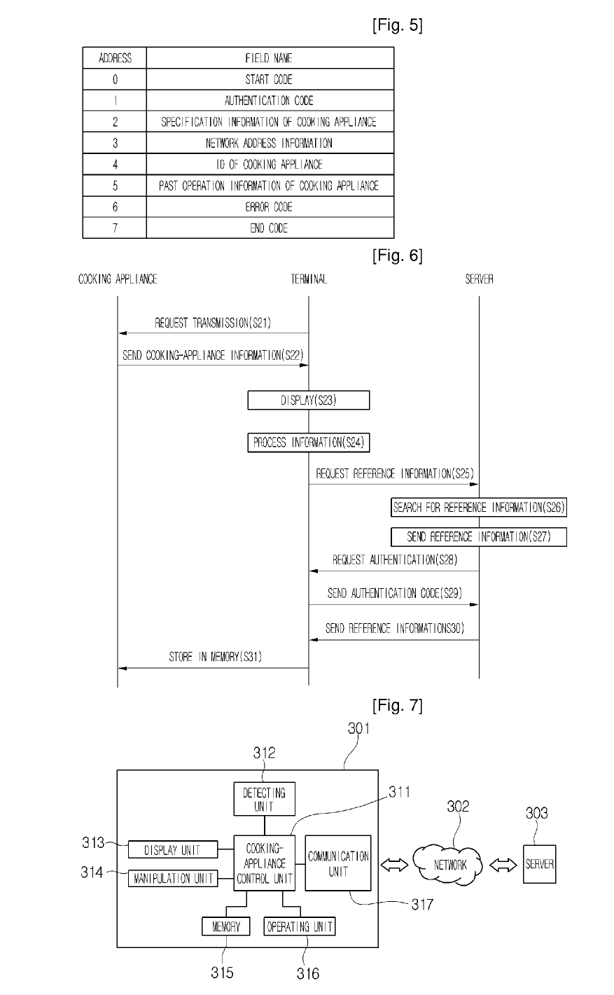

The information transmitted/received between the terminal 202 and the cooking appliance 201 may be organized as a table shown in FIG. 5.

Referring to FIG. 5, the terminal 2 and the cooking appliance 1 exchange information therebetween by using various information. Hereinafter, only differences with the first embodiment will be described. In the controlling system for the cooking appliance according to this embodiment, specification information of a cooking appliance, address information of a network, an ID of the cooking appliance, and past operation information of the cooking appliance are respectively recorded in addresses.

The specification information of the cooking appliance includes resource information of the cooking appliance, such as an installation state of a heater and a calorific value state in the cooking appliance. The ID of the cooking appliance is information used to identify a specific cooking appliance, and one ID is assigned to one cooking appliance. Therefore, the ID allows the server 204 to identify a history of the cooking appliance of the ID. The past operation information of the cooking appliance is information stored in the memory 214, and may be a history of using the cooking appliance.

The terminal 202 reads each peace of information from the cooking appliance 201, and then sends the information to the server 204 by the network connection unit 223 under the control of the terminal control unit 222. The server 204 uses the information to determine a state of the cooking appliance 201, generates predetermined reference information that can be used as a reference of the state of the cooking appliance, and sends the generated information to the terminal 202.

The user can detect an accurate state of the cooking appliance 201 on the basis of the information sent to the terminal 202 and use the information as information for operating the cooking appliance 201. In the case of some information, the information may be sent from the terminal 202 to the cooking appliance 201 and recorded in the cooking appliance 201 to be used as information for actually operating the cooking appliance 201.

FIG. 6 is a flowchart of a method for providing food information according to this embodiment.

Referring to FIG. 6, in operations S21 and S22, a user who wants to examine a state of the cooking appliance 201 to use communicates with the cooking appliance 201 by using the terminal 202 and receives information from the cooking appliance 201.

As described above, the received information of the cooking appliance may be past operation information of the cooking appliance 201, the specification information of the cooking appliance 201, and an ID of the cooking appliance 201. Of course, the information is not limited thereto and may include any information that can be used to determine a state of the cooking appliance 201. For example, predetermined additional information may be further sent by using the manipulation unit 213. In detail, the user can input any characters by using the manipulation unit 213. When the user cooks a specific food, information associated with, e.g., a problem that the food is not cooked enough may be input and sent to the server 204.

In operation S23, the terminal 202 displays information received from the cooking appliance 201. In operation S24, the terminal 202 may append information to the displayed information and allow the user to directly correct the displayed information if the information includes an error.

In operation S25, while sending the information to the server 204, the terminal requests the server 204 to send information that can be used as a reference for the cooking appliance 201. At this time, the server 204 receiving the request has a network address information stored in the cooking appliance 201, and may be a server of a maker of the cooking appliance.

In operation S26, the server 204 having received the request for the reference information searches various reference information. For example, the various information being searched may include a proper method for operating this product such as newly added cooking information for a dish, a new product of a similar kind to the cooking appliance 201, an operating method optimizing the specification of the cooking appliance 201, history information of this product, or video information of a cooking process using this product.

In operation S27, the server 204 processes reference information that is to be directly sent to the terminal 202. When the reference information is processed, a process of determining whether this product has a defect may be further performed with reference to the cooking-appliance information. For example, the operation of the cooking appliance is compared to that of a new product with reference to the past operation information of the cooking appliance, and if it is determined that the cooking appliance has been deteriorated over time and thus requires more time to cook food, error control data may be further included in the reference information. As another example, if there is new control data for the cooking appliance, which are added because of discontent of other users, the data may be further included in processing the reference information.

When the processing process of the reference information is completed, the server 204 requests authentication information of the cooking appliance from the terminal 202 in operation S28. If information of successful authentication is sent in operation S29, the server 204 sends the reference information to the terminal 202 in operation S30.

In operation S31, some of the reference information is sent to the cooking appliance 201 and stored in the memory to be used as information for correcting an operation of the cooking appliance 201. Of course, the information may be displayed on the terminal so that the user can view the information, thereby diversifying usage of the cooking appliance 201. The information stored in the memory may be displayed on the display unit 212 as a new menu when the user operates the cooking appliance, so that the user can operate the cooking appliance by a new method on the basis of the displayed information.

Of course, the reference information that is not recognized by the user may include information for correcting operation information of the cooking appliance. When the user commands the same dish as in the past, this information is used to correct an operating manner of the operating unit 215 even if the same dish is displayed on the display unit 212 in the same manner. In another case, if the user inputs an inquiry or a specific requirement through the manipulation unit 213, an answer thereto may be included in the reference information.

According to this embodiment, the user can optimize an operational state of the cooking device even though use time of the cooking appliance elapses. In some cases, a course dish may be added as a new cooking method. Therefore, use's satisfaction increases and the product can be used for a longer period of time.

The second embodiment may have the following modification example.

Because the specification information of the cooking appliance may be recognized by the server from the ID of the cooking appliance, it may not be provided. However, as the specification information is provided from the cooking appliance, the server can stably recognize the cooking appliance.

Also, the authentication request operation S28 and the authentication code sending operation S29 between the server and the terminal may be performed between the food information request operation S25 and the food information sending operation S30 between the terminal and the server. The specific order of performing those processes is not irrelevant.

The storing operation S31 in the memory has been described as a necessary process. However, convenience in using the cooking appliance can be implemented by just displaying the information received from the server 204 to the terminal 202 on the terminal 202 to allow the user to view the displayed information. Examples of information that may be only displayed on the terminal 202 include video information of the cooking appliance and a new product similar to the cooking appliance. Of course, if necessary, a new use method of the oven may be recognized by the user, so that the user can use the oven by manually manipulating the cooking appliance.

According to this embodiment, the cooking appliance can be manipulated conveniently into a state desired by a user and can be used as if it is new without any inconvenience in use even after the long time use of the cooking appliance. Also, because the amount of information recorded in an internal memory of the cooking appliance can be increased, user's convenience can be improved and the user can be easily informed of various information associated with the cooking appliance, thereby further increasing satisfaction of the user.

### Third Embodiment

In the first and second embodiments, additional information of food and control information of a cooking appliance are provided through a terminal. However, there is still a limitation of incapability of receiving detailed control information for the cooking appliance. In other words, according to the previously embodiments, it is possible to update control information for the cooking information by one-time downloading of control information for the cooking appliance in a sufficiently long time interval, but it is difficult to update control information for the cooking appliance with respect to a food that is currently being cooked. The third embodiment of the present invention proposes a controlling system and a controlling method for a cooking appliance that can cook food more optimally in due consideration of the above limitation.

FIG. 7 is a block diagram of a controlling system for a cooking appliance according to the third embodiment.

Referring to FIG. 7, the controlling system according to this embodiment includes a cooking appliance 301, a server 303, and a network 302. The server 303 receives actual state information of an actual operation of the cooking appliance and sends corrected control information. The network connects the cooking appliance 301 with the server 303.

In detail, the cooking appliance 301 includes a cooking-appliance control unit 311, a display unit 313, a manipulation unit 314, a memory 315, and an operating unit 316. The cooking-appliance control unit 311 controls the cooking appliance 301 on the whole, the display unit 313 displays an operational state of the cooking appliance 301, and the manipulation unit 314 allows a user to manipulate the cooking appliance 301. The memory 315 stores current control information required for a current operation of the cooking appliance 301, and the operating unit 316 includes, e.g., a heater that directly operates under the control of the cooking-appliance control unit 311.

The cooking appliance 301 further includes a detecting unit 312 and a communication unit 317. The detecting unit 312 detects an actual operating state of the cooking appliance 301, and the communication unit 317 sends information of the actual state to the server 303 or receives corrected control information from the server 303.

The detecting unit 312 can detect information of a temperature, a moisture and smoke. The memory 315 may further store target state information, which is a target operation state when the cooking appliance 301, particularly, the operating unit 316 normally operates with the current control information. Besides, the memory 315 further stores specification information of the cooking appliance 301 to allow the server 303 to identify the specification of the cooking appliance 301.

The network may be any one of wired/wires/home networks. In a general case, the network may be an Internet network.

A calibration method will now be described briefly with reference to the block diagram of FIG. 7. First, the user manipulates the manipulation unit 314 and selects a specific operation mode. Hereinafter, a baking mode will now be described as an example of the specific operation mode.

When the baking mode is selected, the cooking-appliance control unit 311 identifies the selected baking mode, calls for current control information suitable for baking, which is stored in the memory 315, and operates the operating unit 316 according to the current control information. After the operation of the operating unit 316, the detecting unit 312 detects state information of the cooking appliance 301 obtained by operation of the operating unit 316 and stores the detected information in the memory 315 as actual state information. Examples of the detected state information include a temperature, a moisture and smoke.

The actual state information is sent to the server 303 by the communication unit 317. The server 303 compares the actual state information with the target state information to detect a defective operation of the operating unit 316, and generates corrected control information for actually achieving the target state information when the operating unit 316 operates. Of course, it can be understood that the corrected control information is one that allows the baking mode to be most properly performed by the cooking appliance 301 in a current state.

The corrected control information is sent from the server 303 to the cooking appliance 301 and is stored as current control information for operating the cooking appliance 301. That is, current control information previously stored in the memory 315 is discarded, and the corrected control information is stored as new control information. Therefore, when the user performs a baking mode afterwards, the cooking appliance 301 is operated on the basis of the corrected control information, so that bread can be baked properly.

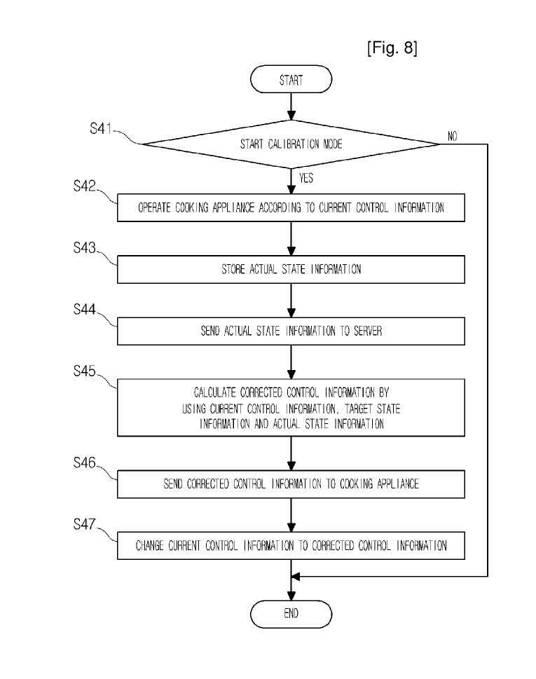

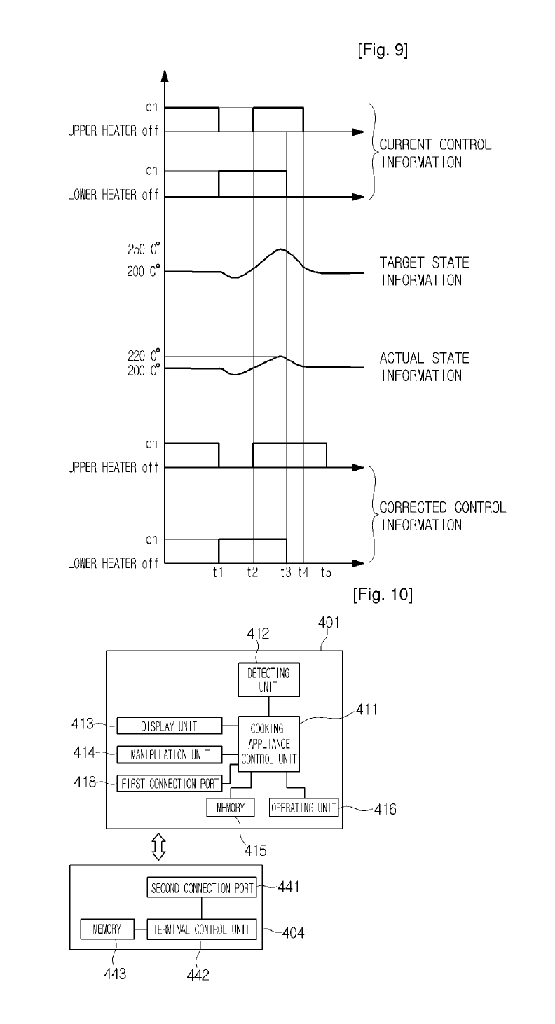

FIG. 8 is a flowchart for explaining a method for correcting control information for the cooking appliance according to the this embodiment. FIG. 9 illustrates an example of current control information, target state information, actual state information and corrected control information.

Referring to FIGS. 8 and 9, a controlling method for the cooking appliance will now be described in detail.

In operation S41, a user determines whether to start a calibration mode. The calibration mode may be started by, e.g., pressing a calibration button when the user selects a baking mode through the manipulation unit 314.

In operation S42, when the calibration mode is started, the cooking appliance is operated by using current control information. A state of the cooking appliance operated on the basis of the current control information is detected by the detecting unit and stored in the memory as actual state information in operation S43. In operation S44, the stored actual state information is sent to the server together with the current control information and the target state information. In operation S45, corrected control information is generated at the server with reference to the sent information. The corrected control information allows backing to be optimally performed at the cooking appliance.

Referring to FIG. 9, a process of generating the corrected control information will now be described in more detail. When the user executes the baking mode, in the current control information an upper heater is preheated for a predetermined time t1 and then a lower heater is turned on for a predetermined time t1 to t3. In the backing mode, the upper heater is turned on again for a predetermined time t2 to t4 in order to increase an heating degree and sufficiently brown a surface of bread.

As shown in FIG. 9, in the target state information, the inside of a cavity increases in temperature up to 250° C. to brown the surface of the bread. It is assumed that a temperature sensor is placed at an upper space of the cavity.

However, a situation in which the temperature does not reach 250° C. proposed in the target state information may occur because of deterioration of the heater over time. For example, the temperature increases only up to 220° C. in the actual state information. The server can generate corrected control information with reference to the current control information, the target state information and the actual state information. The corrected control information is used for calibration of turning on the upper heater for a longer time t2 to t5 so as to allow the temperature to reach a desired temperature. Of course, the server may control output of the upper heater.

The corrected control information becomes control information that makes actual state information similar or identical to the target state information.

After the corrected control information is generated, the corrected control information is sent to the cooking appliance in operation S46. In operation S47, the sent corrected control information is stored as new current control information instead of the current control information. It can be easily understood that baking will be performed by using the corrected current control information in a subsequent baking mode.

The current control information is sent to the server after generated as a single set of data in the above description but is not limited thereto. For example, the current control information is sent to the server in real time, and the server may send corrected control information with reference to the current control information in real time.

### Fourth Embodiment

The fourth embodiment is the same as the third embodiment in that actual state information is generated at the cooking appliance, but unlike the third embodiment, target state information and current control information are not separately sent in the fourth embodiment. Therefore, the description of the third embodiment is applied to parts of the fourth embodiment that are not specifically described.

In the information sending operation S44, the server receives actual state information together with specification information of the cooking appliance and current cooking mode information. A baking mode is used as an example of the current cooking mode in the following description. Then, the server calculates target state information and current control information with reference to the actual state information, the specification information of the cooking appliance and the current cooking mode information. Then, the server compares the calculated information with the actual state information to generate corrected control information.

Otherwise, the fourth embodiment is the same as the third embodiment, and thus the detailed description thereof will be omitted.

### Fifth Embodiment

The fifth embodiment is similar to the third embodiment in many parts. As for a difference therebetween, in the third embodiment the server receives the actual state information generated at the cooking appliance and generates corrected control information, but in the fifth embodiment, a separate terminal performs such processes. The description of the first embodiment is applied for parts that are not specifically described.

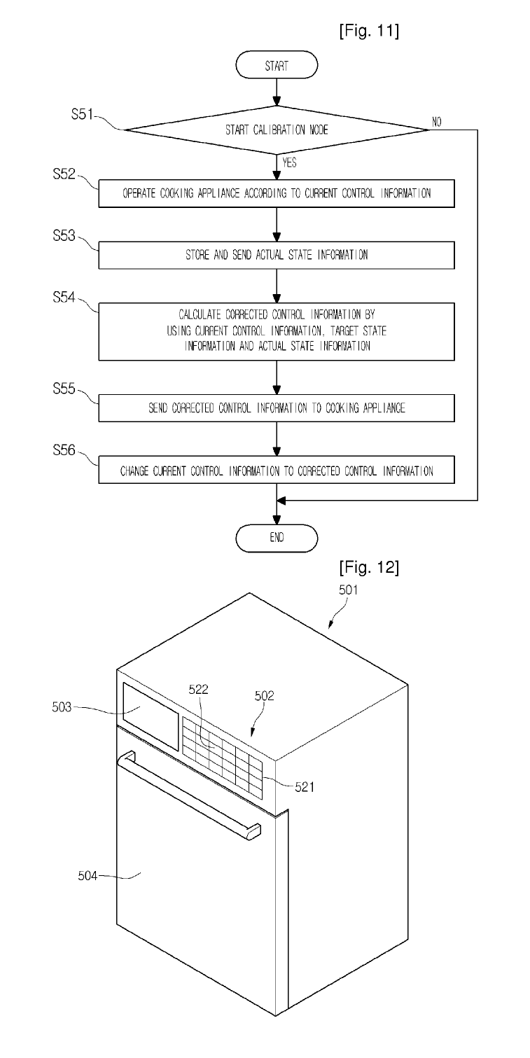

FIG. 10 is a block diagram of a controlling system for a cooking appliance according to the fifth embodiment, and FIG. 11 is a flowchart of a controlling method for a cooking appliance according to the fifth embodiment.

Referring to FIGS. 10 and 11, a cooking appliance 401 according to this embodiment includes a first connection port 418 instead of the communication unit 317, the network 302 and the server 303 of the third embodiment. A terminal 404 connected to the first connection port 418 includes a second connection port 441 directly connected to the first connection port 418 by wire, a terminal control unit 442 controlling the terminal 404, and a memory 443 storing therein information required for generation of corrected control information.

According to this system configuration, actual state information detected in the cooking appliance 401 is sent to the terminal 404 in operations S51, S52 and S53. Then, corrected control information is generated in the terminal 404 and sent to the cooking appliance 401 in operations S54 and S55. In such a manner, current control information of the cooking appliance 401 can be updated in operation S56. The above operations can sufficiently implement this embodiment for calibrating control information. From another aspect, more stable operation can be performed according to this embodiment because there is no need to use the network 302 as in the third embodiment.

The system according to this embodiment can be desirably used when a service man visit home to calibrate control information. Therefore, in this case, a user may previously store the actual state information.

According to this embodiment, it can be easily understood that the terminal can detect the target state information and current control information with reference to specification information of the cooking appliance and current cooking mode information, and then generate corrected control information with reference to actual state information.

The third, fourth and fifth embodiments may have the following modifications.

In the description, the server or the terminal generates the corrected control information, but embodiments are not limited thereto. If capacity of the control unit and that of the memory in the cooking appliance are sufficient, the cooking appliance can perform calibration with reference to actual state information.

### Sixth Embodiment

The sixth embodiment is the same as the third embodiment in that a cooking appliance is connected to a cooking appliance via a network. However, in the sixth embodiment, the cooking appliance is used as one terminal, so that a user manipulates the cooking appliance to receive desired information. Also, according to this embodiment, detailed information can be obtained in the form of questions and answers, and thus the user can more conveniently use the cooking appliance.

FIG. 12 is a perspective view of an oven being used in the description of the sixth embodiment. The oven is merely an example, and the embodiment may be easily applied for other types of cooking appliances.

A cooking appliance 501 according to this embodiment includes a door 504, a character input unit 502 disposed near to the door 504, and a display unit 503.

In detail, the character input unit 502 is used to receive a specific sentence when a user asks a question. To this end, the character input unit 502 includes a plurality of character input buttons 521, and the user may form a sentence by pressing the character input buttons 521. Of course, an answer to the question of the user is output on the display unit 503, so that the user can recognize the answer.

The display unit 503 is a component that is exemplified as a liquid crystal display (LCD) module. A moving image with a predetermined size is provided to the display unit 503. The display unit 503 displays a question of the user so that the user can check the accuracy of the question, and also displays information proposed by information stored in the cooking appliance 501 or information sent from a server.

Of course, other manipulation operations of the user for controlling the cooking appliance can be performed through the character input unit 502. Also, the character input unit 502 may further include a separate send button 522 to send the question of the user to the server.

An operation of the cooking appliance will now be described in more detail with reference to a block diagram.

FIG. 3 is a block diagram of a controlling system for a cooking appliance according to this embodiment.

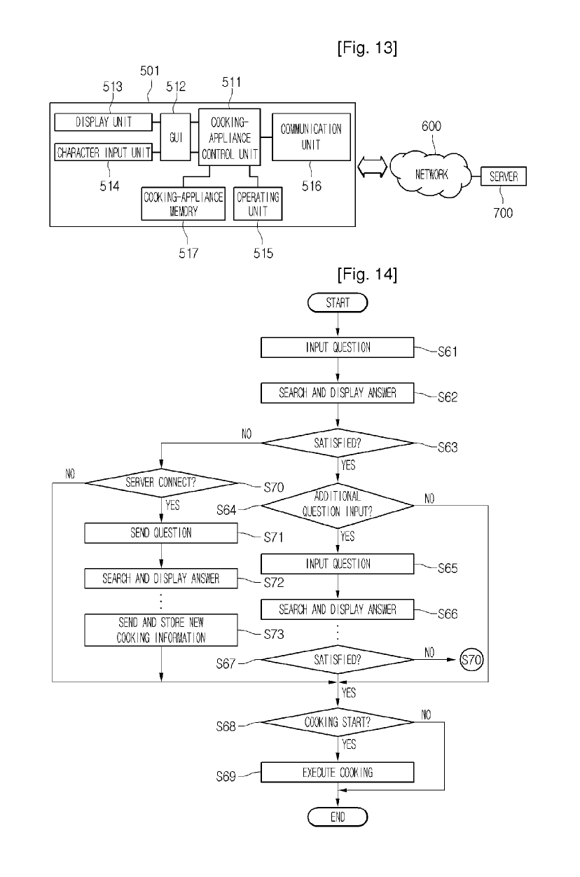

Referring to FIG. 13, the system according to this embodiment includes a cooking appliance 501, and a server 700 connected to the cooking appliance 501 via a network 600.

In detail, the cooking appliance 501 includes a cooking-appliance control unit 511 controlling an entire system of the cooking appliance 501, a character input unit 514 through which a user input a quest to the cooking appliance 501, a display unit 513 displaying an operation state of the cooking appliance 501 and question information input by the user, and a graphic user interface (GUI) 512. The graphic user interface 512 interconnects the character input unit 514 and the display unit 513 so that information therebetween can interact, and thus provides various graphic information to the user. The cooking appliance 501 further includes a cooking-appliance memory 514 including various information used to guide a cooking process. Also, the cooking appliance 501 further includes a communication unit 516 connecting the cooking appliance 501 with the external server 700 via the network 600, and a plurality of components such as a plurality of heaters mounted in the cooking appliance 501, which are required for an operation of the cooking appliance 501.

The network 600 may be one or both of wired/wireless networks. In another case, the network 600 may be a home network, and the server 700 may be a home server installed at home.

The server 700 is a server operated by a maker of the cooking appliance 501, and may be a server for providing a service to the cooking appliance 501. The general server configuration has been known from various existing materials, and the known configuration is applied to the server according to this embodiment. Of course, the server includes a server memory storing cooking information provided to the user, a communication unit performing communication with the cooking appliance, and a control unit searching the server memory with reference to at least a question sent from the cooking appliance.

An operation of a guide system as described above will now be described in detail.

To ask a question, the user inputs a sentence or a simple keyword by using the character input unit 514. Since a character that the user inputs is displayed on the display unit 513, the accuracy of the input can be checked.

The cooking appliance 501 primarily searches the cooking-appliance memory 517 to find a proper answer to input information input through the character input unit 514, and outputs the searched answer to the display unit 513. The answer may include cooking information for controlling the cooling appliance 501 to cook a specific food, and video information showing a cooking state.

The questioning of the user and the answering from the cooking-appliance memory 517 can be repetitively performed. If the user is satisfied with cooking information obtained after the questing and answering procedure, the user may command the cooking appliance 501 to operate according to the corresponding cooking information.

If the information recorded in the cooking-appliance memory 517 is not satisfactory, an answer can be made by interaction with the server 700. Of course, in this case, the questioning of the user and the answering from the cooking-appliance memory 517 may be continuously performed, and the food can be cooked by controlling the cooking appliance 501 after the cooking information is sent and recorded in the cooking-appliance memory 517.

In this embodiment, when the user directly inputs a question, the user may primarily receive an answer to the question through the cooking-appliance memory 517 mounted in the cooking appliance 501 and may secondarily receive the answer through the server memory mounted in the server. Therefore, a possibility of receiving a satisfactory answer or cooking information for more accurate control over the cooking appliance can be increased.

The answer may include video information, and in this case, the user can cook food, watching the video information, thereby improving user's convenience.

Since the answer includes information obtained in consideration of specification information of a specific corresponding cooking appliance, the cooking information becomes more accurate.

Hereinafter, a cooking guide method according to this embodiment will now be described with reference to FIG. 14.

Referring to FIG. 14, in operation S61, a user inputs a sentence or a keyword including a question through the character input unit 502 provided at the cooking appliance 501. The cooking-appliance memory 517 is searched for an answer to the input question under the control of the cooking-appliance control unit 511, and then the answer is displayed on the display unit 513. The answer may include cooking information, video information of a cooking process, information as an answer requesting further information to solve obscurity of the current question, or option information that may correspond to the question.

In operation S63, it is determined whether the user is satisfied with the answer. In operation S64, if the user is satisfied with the answer, an additional question may be continuously input. If not, cooking may be executed according to currently provided cooking information in operation S68. In operation S70, if the user is not satisfied with the current answer, it is determined whether to connect the cooking appliance with the server 700. If the connection with the server is not made, the cooking is directly executed in operation S68. If the connection with the server is made, questioning and answering can be continuously performed in connection with the server.

Even if the current answer is satisfactory, the user can make an addition question in operation S64. In this case, the question input operation S65 and the answer searching and displaying operation S62 are performed. The questing and answering may be performed repetitively. If there is an answer which the user is not satisfied with during any questioning and answering processes in operation S67, it can be determined whether to connect the cooking appliance with the server 700 in operation S70.

If the user is satisfied with current cooking information and other associated information while performing questioning and answering with the cooking-appliance memory 517, it is determined whether to start cooking in operation S68. If the cooking is started but a material is not yet prepared, the cooking information may be set to a wait state and after the material is prepared, the cooking may be executed in operation S69.

AS described above, the user primarily searches the cooking-appliance memory 517 for information by using the character input unit 514 and the display unit 513. However, since the information recorded in the cooking-appliance memory 517 is limited because of limited capacitance and limited search functions, the user may face an unsatisfactory situation. In this case, it is determined whether to connect the cooking appliance with the server 700 in operation S70. When the connection with the server 700 is made, the questioning and answering is continuously performed in operations S71 and S72. When the cooking appliance is connected with the server, specification information or specific information of the cooking appliance may be sent together with a question, so that more desirable information can be searched from the server 700.

When the connection with the server is not made, it is determined whether to start cooking by using the current cooking information in operation S68, thereby executing or completing the cooking process. When the connection with the server 700 is made and thus an additional answer is received from the server 700, new cooking information can be received from the server and stored in operation S73. Of course, thereafter, it is determined whether to start the cooking in operation S68, thereby executing the cooking process in operation S69 or completing the process.

In the cooking guide method according to this embodiment, when the user inputs a question by using characters, an answer thereto is primarily searched and displayed in the cooking appliance. If the answer from the cooking appliance is not satisfactory, the cooking appliance accesses the server to continuously perform additional questioning and answering. Therefore, more various and accurate information can be acquired. Since the question is input through characters, accurate search can be performed regardless of information.

Also, cooking information for directly controlling the cooking appliance is provided to the memory of the cooking appliance or the memory of the server, and the cooking information includes an answer. The cooking information may be used as control data for directly controlling the cooking appliance in a state of being recorded in the cooking-appliance memory 517. Therefore, the user can conveniently cook food to a desired state.

Also, the cooking-appliance memory and the server memory provide optimum cooking information as an answer by checking specification information or specific information of the cooking appliance 501. Accordingly, accuracy of the cooking information is improved.

### Seventh Embodiment

The seventh embodiment provides a cooking guide method that can improve convenience as compared to the sixth embodiment. The description of the sixth embodiment is used for parts that are not specifically described, and only differences of this embodiment from the sixth embodiment will be described in detail.

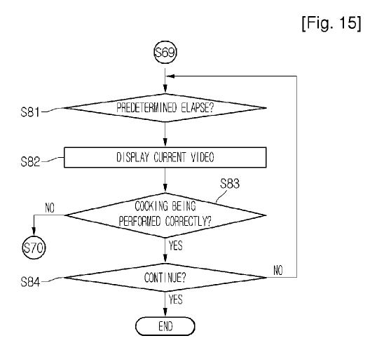

FIG. 15 is a flowchart for explaining a controlling method for a cooking appliance according to the seventh embodiment.

Referring to FIG. 15, this embodiment starts from executing a cooking process in operation S69. After cooking is started and a predetermined time elapses in operation S81, an image showing a cooked state of a food at the predetermined time is displayed among images provided as an answer in operation S82. A user compares an image being displayed with the current cooked state of the food being cooked to determine whether the cooking is executed correctly. In operation S83, if the cooking is not executed correctly, it can be determined whether to perform the connecting operation S70 of the cooking appliance with the server again. In this case, after new cooking information is received in operation S73, the cooking of the food can be continued.

Of course, if the current cooked state of the food is satisfactory, the cooking is continued in operation S84. After the predetermined time S81, a current moving image can be viewed again in operation S82.

According to this embodiment, it is additionally determined whether the cooking is correctly executed to cope with a cooked state of the food. Accordingly, the food can be cooked to an optimum state all the time.

When it is determined whether the cooking is correctly executed in operation S82, if the current cooking information is information recorded in the cooking-appliance memory, the operation S61 of inputting a question to the cooking memory is be performed so that questioning and answering processes can be performed.

The sixth and seventh embodiments may have the following modification examples.

Characters are input by pressing buttons of the character input unit in the above description, but embodiments are not limited thereto. For example, the character input unit 502 may operate into a touch sensor type, and thus characters can be input by touching a screen. Furthermore, the display unit 503 may operate into a touch sensor type for character input without using a separate character input unit 502.

If the cooking-appliance memory mounted in the cooking appliance can have large capacity, the user may obtain satisfactory information only with the information stored in the cooking-appliance memory. Of course, if the memory cannot be provided in the cooking memory, the cooking appliance may be connected to the server all the time to receive an answer therefrom.

### INDUSTRIAL APPLICABILITY

According to embodiments, a user can acquire recent information associated with food in real time, and a range of food information provided to the user is diversified. Accordingly, the user can conveniently manipulate a cooking appliance in a specified and correct manner depending on a state of the food, obtain information optimized according to specification information of the cooking appliance and use the cooking appliance for a long time without any inconvenience as if it is new. Also, since the amount of use information of the cooking appliance and food information recorded in an internal memory can be increased, control information for the cooking appliance can be calibrated, which offers convenience in use. Also, a limited usable term of the cooking appliance, which results from a controlling method can be overcome, and a cooking process of the user can be guided correctly.

Accordingly, the cooking appliance is expected to be usefully used.

1. A controlling system for a cooking appliance comprising:
a cooking appliance including at least a heating unit;
a server connected to the cooking appliance to receive reception information from the cooking appliance and send transmission information processed with reference to the reception information to the cooking appliance; and
a network including at least one node to connect the cooking appliance with the server.

2. The controlling system according to claim 1, further comprising a terminal relaying the cooking appliance and the server.

3. The controlling system according to claim 1, wherein the reception information includes at least specific food information, and the transmission information includes at least information associated with the specific food information.

4. The controlling system according to claim 3, wherein the specific food information is selected by a user.

5. The controlling system according to claim 1, wherein the reception information includes at least specification information of the cooking appliance, and the transmission information includes information prepared in consideration of the specification information of the cooking appliance.

6. The controlling system according to claim 1, wherein the reception information includes at least unique information for identifying the cooking appliance, and the transmission information includes service information of the cooking appliance or recent information of the cooking appliance.

7. The controlling system according to claim 1, wherein the reception information includes at least current control information and actual state information of the cooking appliance, and the reception information includes corrected control information.

8. The controlling system according to claim 1, wherein the reception information includes at least a question of a user, and the transmission information includes an answer to the question.

9. The controlling system according to claim 8, wherein the question and the answer are repetitively made.

10. A controlling system for a cooking appliance, the controlling system comprising:
a wireless transmitter mounted in a cooking appliance;
a terminal receiving transmission information sent from the wireless transmitter; and
a server connected to the terminal via a network and providing food-associated information with respect to the transmission information sent from the terminal, wherein the wireless transmitter sends at least specific food information, and the food-associated information is information associated with the specific food information.

11. The controlling system according to claim 10, wherein the wireless transmitter sends specification information of the cooking appliance together with the food information, and the food-associated information includes at least data of an oven operating method.

12. A controlling system for a cooking appliance, the controlling system comprising:
a cooking appliance including therein a first communication unit;
a terminal including therein a second communication unit installed to receive information of the cooking appliance from the first communication unit; and
a server processing information of the cooking appliance input from the terminal and sending reference information of the cooking appliance to the terminal.

13. The controlling system according to claim 12, wherein the information of the cooking appliance includes at least unique information of the cooking appliance.

14. The controlling system according to claim 12, wherein the reference information of the cooking appliance includes service information of the cooking appliance or recent information of the cooking appliance.

15. The controlling system according to claim 12, wherein the information of the cooking appliance includes identification information of the cooking appliance, and past operation information of the cooking appliance, and the reference information of the cooking appliance includes information used to calibrate an operational state of the cooking appliance by analyzing an operation of the cooking appliance.

16. The controlling system according to claim 15, wherein the information used to calibrate the operational state of the cooking appliance is stored in the cooking appliance and is used as operation information of the cooking appliance.

17. A controlling system for a cooking appliance, the controlling system comprising:
a cooking appliance including therein at least a heater; and
a server connected to the cooking appliance,
wherein the cooking appliance comprises:
a memory storing current control information;
an operating unit operating according to the current control information;
a detecting unit detecting an operational result of the operating unit; and
a communication unit sending at least actual state information detected at the detecting unit to the server, wherein the server generates corrected control information with reference to at least the actual state information and sends the corrected control information to the cooking appliance, and
the cooking appliance changes the corrected control information to current control information.

18. The controlling system according to claim 17, wherein the cooking appliance sends the actual state information to the server in real time.

19. The controlling system according to claim 17, wherein the cooking appliance processes the actual state information into one set of data and sends the data to the server.

20. A cooking appliance comprising:
an operating unit including at least a heater;
a detecting unit detecting actual state information resulting from an operation by the operating unit; and
a memory storing current control information for currently operating at least the operating unit, and the actual state information.

21. A controlling system for a cooking appliance, the controlling system comprising:
a cooking appliance comprising a character input unit through which a user inputs a character, and a display unit displaying information; and
a server connected to the cooking appliance via a network and comprising a memory storing therein food information of various food, wherein a question input through the character input unit is sent to the server, and an answer to the question is sent to the cooking appliance and displayed on the display unit to be used to cook food.

22. The controlling system according to claim 21, wherein the answer includes video information.

23. The controlling system according to claim 21, wherein the character input unit operates as a touch type.

24. The controlling system according to claim 21, wherein the answer includes cooking information for actual operation of the cooking appliance.

25. A controlling system for a cooking appliance that cooks food by heating, the cooking appliance comprising:
a character input unit through which a user inputs a question using characters;
a display unit displaying the characters input through the character input unit and an answer to the question;
a memory storing therein the answer to the question; and
a cooking-appliance control unit searching the memory for the answer to the question and controlling such that the searched answer is displayed on the display unit.

26. A controlling method for a cooking appliance, the method comprising:
inputting a question using characters through a character input unit of a cooking appliance;
searching a memory of the cooking appliance and/or a memory of a server connected with the cooking appliance via a network for an answer to the question;
outputting the answer to a display unit of the cooking appliance;
storing cooking information including the answer in the memory of the cooking appliance, the cooking information being used to control the cooking appliance; and
operating the cooking appliance according to the cooking information.

27. The controlling method according to claim 26, wherein the cooking information includes video information of a cooking process of food, wherein the controlling method further comprises displaying the video information at a predetermined time interval when the cooking appliance is operated according to the cooking information.

28. The controlling method according to claim 26, wherein the searching for the answer comprises searching the memory of the cooking appliance and then searching the memory of the server.

29. A controlling method for a cooking appliance, the method comprising:
operating a cooking appliance according to pre-stored current control information;
measuring actual state information of the cooking appliance resulting from an operation based on the current control information;
comparing the actual state information with ideal target state information which the current control information is aimed at; and
calibrating the current control information of the cooking appliance into corrected control information.

30. The controlling method according to claim 29, wherein the corrected control information of the cooking appliance is sent to the cooking appliance from an external server.
